(19) United States
(12) Patent Application Publication
(10) Pub. No.: US 2007/0162368 A1
(43) Pub. Date: Jul. 12, 2007

(54) Methods and systems for providing, via an application service provider model, assistance to financial professionals by enumerating available resources to improve an analysis of a client and an identification of client needs by the financial services professional

(76) Inventor: Donald R. Delf JR., Plano, TX (US)

Correspondence Address: Attn: John D. Lanza;PATENT GROUP, Choate, Hall & Stewart, Two International Place, Boston, MA, 02110, US

(21) Appl. No.: 11/328,430

(22) Filed: Jan. 9, 2006

(51) Int. Cl. G06Q 40/00

(52) U.S. Cl. 705/35

(57) ABSTRACT

In an application service provider model, a method for enumerating available resources to improve an analysis of a client and an identification of client needs by a financial services professional includes the step of enumerating a plurality of techniques. A network transmission including at least one characteristic associated with a client is received. A subset of the plurality of techniques is enumerated, responsive to the received at least one characteristic. Access is provided across a network to a resource associated with the enumerated subset of techniques.

### FIELD OF THE INVENTION

The present invention relates to a method and system for enumerating resources and, in particular, to a method and system for enumerating available resources to improve an analysis of a client and an identification of client needs by a financial services professional.

### BACKGROUND OF THE INVENTION

Conventional systems for assisting financial services professionals may provide access to resources regarding financial planning techniques, tools for modeling or analyzing a financial state of a client, or report-generation tools. These systems are typically limited in several ways, posing several challenges for financial services professionals.

One challenge faced by financial services professionals is the need to model effects of financial planning decisions on individuals or entities other than a client of the financial service professionals. In many situations, a financial planning decision made by a client affects entities related to the client and an analysis of those effects is required in the decision-making process. A system modeling an effect of a decision made by a client on the client and on an entity related to the client would assist the client and the financial services professional in making appropriate financial planning decisions. Additionally, a vast amount of information is collected in such a system—information associated with the client, with entities associated with the client, identification of the relationship between the client and each entity associated with the client, information associated with a financial planning decision and the effects of the decision on the client and on entities associated with the client. An interactive, graphical representation of such a model enabling users to navigate the web of relationships between the client and entities related to the client and all related information would be desirable.

Another challenge faced by financial services professionals is the need to identify the financial planning techniques most appropriate for a particular client. Conventional systems providing access to financial planning resources typically fail to assist financial services professionals in the selection of the appropriate resources. Resources may be so numerous that the financial services professional is not aware of all of the resources. In some instances, a financial services professional may become proficient in the use of certain planning techniques and accompanying resources to the exclusion of other valuable and relevant techniques and resources. Tools to assist the financial services professional in identification of the goals and objectives of clients and of relevant tools and resources would be desirable.

Still another challenge faced by financial services professionals is the need to tailor a presentation of information for use in making a financial planning decision. In some situations, when making a financial planning decision, it would be desirable to view and analyze the differences between various planning scenarios. A client may wish to view a model of an effect of one financial planning decision on an entity related to the client and simultaneously view a model of an effect of a different financial planning decision on the entity. A system providing access to both a model of an effect and a modification of the model would be desirable in the decision-making process.

Yet another challenge faced by financial services professionals is the need to tailor a presentation of information to a client through generation of customized reports. In some instances, multiple types of reports may be available for clients of financial services professionals. However, the number of reports available may be so numerous as to be unmanageable and have decreased utility for the client. Some conventional systems may provide exhaustive information about the client but fail to include relevant information regarding entities associated with the client. Other conventional systems may require the presentation of the entire report without providing the option to select presentation of only a portion of a report. Still other conventional systems may enable selection of a predetermined subset of information within a report without allowing a user to select desired information. A system enabling a client to select relevant reports or reporting components associated with entities, transactions, or assets related to the client, as opposed to entire reports associated with only the client, would be desirable.

### BRIEF SUMMARY OF THE INVENTION

The present invention relates to a method and system for enumerating available resources to improve an analysis of a client and an identification of client needs by a financial services professional. In one aspect, in an application service provider model, the invention relates to a method for enumerating available resources to improve an analysis of a client and an identification of client needs by a financial services professional. A plurality of techniques is enumerated. A network transmission including at least one characteristic associated with a client is received. A subset of the plurality of techniques is enumerated, responsive to the received at least one characteristic. Access is provided across a network to a resource associated with the enumerated subset of techniques.

In one embodiment, a plurality of techniques for use in financial planning is enumerated. In another embodiment, a network transmission is received including at least one questionnaire comprising information provided by a client. In still another embodiment, a second characteristic is requested from the client responsive to receiving the at least one characteristic. In yet another embodiment, a network transmission is received including at least one characteristic associated with a client, the at least one characteristic identifying a financial planning topic associated with the client.

In one embodiment, a subset of the plurality of techniques is enumerated, the subset addressing a need of the client. In another embodiment, access is provided across a network to a display of a plurality of answers to frequently asked questions, the plurality of answers associated with a technique in the enumerated subset of techniques. In still another embodiment, access is provided across a network to a display of a financial planning model associated with a technique in the enumerated subset of techniques. In yet another embodiment, a customized user-interface is generated responsive to the subset of techniques.

In another aspect, in an application service provider model, the invention relates to a system for enumerating available resources to improve an analysis of a client and an identification of client needs by a financial services professional. The system includes an enumeration of a plurality of techniques displayed in a user interface, at least one characteristic associated with a client, an enumeration of a subset of the plurality of techniques, and a resource. The at least one characteristic is transmitted across a network. The subset of the plurality of techniques in the enumeration is selected responsive to the at least one characteristic. The resource is associated with the enumerated subset of techniques.

In one embodiment, the enumeration further comprises an enumeration of at least one resource associated with a technique in the plurality of techniques. In another embodiment, the at least one characteristic further comprises an identification of a financial planning goal associated with the client. In still another embodiment, the enumeration of the subset comprises at least one technique enumerated responsive to a request for information about the at least one technique.

In one embodiment, the resource is displayed to the client across a network. In another embodiment, the resource further comprises a tutorial associated with a technique in the enumerated subset of techniques. In still another embodiment, the resource further comprises a display of a financial planning model associated with a technique in the enumerated subset of techniques. In some embodiments, the system further includes a customized user-interface generated responsive to the subset of techniques. In other embodiments, the system further includes a customized user-interface implemented to determine, responsive to an association between a first entity and financial and data, an effect on an entity in a plurality of entities related to the first entity.

### BRIEF DESCRIPTION OF THE DRAWINGS

These and other aspects of this invention will be readily apparent from the detailed description below and the appended drawings, which are meant to illustrate and not to limit the invention, and in which:

FIG. 1A is a block diagram depicting one embodiment of a system in which a local machine communicates with a remote machine across a network;

FIGS. 1B and 1C are block diagrams depicting embodiments of computers useful in connection with the present invention;

FIG. 2A is a flow diagram depicting one embodiment of the steps taken in a method for determining an effect of a financial decision on a plurality of related entities;

FIG. 2B is a screen shot depicting one embodiment of a graphical representation of a first entity and a plurality of entities;

FIG. 2C is a screen shot depicting one embodiment of a user interface receiving data associated with a first entity;

FIG. 2D is a screen shot depicting a second embodiment of a user interface receiving data associated with a first entity;

FIG. 2E is a screen shot depicting one embodiment of a user interface receiving financial data associated with the first entity;

FIG. 2F is a screen shot depicting one embodiment of user interface receiving estate planning data associated with the first entity;

FIG. 3A is a block diagram depicting an embodiment of a first association between a first entity and each entity in a plurality of entities related to the first entity;

FIG. 3B is a screen shot depicting one embodiment of a graphical representation of a first entity and a plurality of entities related to the first entity;

FIG. 3C is a screen shot depicting one embodiment of a user interface enabling transmission of additional information for association with a first entity;

FIG. 3D is a screen shot depicting one embodiment of a graphical representation of a second association between the first entity and financial data;

FIG. 3E is a screen shot depicting one embodiment of a reporting component providing access to a model of an effect of a second association;

FIG. 3F is a screen shot depicting one embodiment of a model of an effect on an entity;

FIG. 3G is a flow diagram depicting one embodiment of the steps taken in a method for determining an effect of a financial decision on a plurality of related entities;

FIG. 3H is a screen shot depicting one embodiment of a user interface enabling a user to customize data associated with an entity in the plurality of entities;

FIG. 4A is a screen shot depicting one embodiment of an identification of a plurality of transactions relating to financial data;

FIG. 4B is a screen shot depicting one embodiment of an identification of a plurality of transactions relating to estate planning decisions;

FIG. 4C is a screen shot depicting one embodiment of an identification of a plurality of transactions relating to asset allocation;

FIG. 4D is a screen shot depicting one embodiment of a model of values of financial data associated with the first entity and an entity in the plurality of entities;

FIG. 4E is a screen shot depicting one embodiment of a model presented of a modification to associations between the first entity and financial data and the plurality of entities;

FIG. 4F is a flow diagram depicting one embodiment of the steps taken in a method for assisting a financial services professional to tailor a presentation of information to a client;

FIG. 5A is a flow diagram of one embodiment of the steps taken in a method for enumerating available resources to improve an analysis of a client and an identification of client needs by a financial services professional;

FIG. 5B is a screen shot depicting one embodiment of an enumeration of a plurality of techniques providing a user with an opportunity to request additional information about a particular technique;

FIG. 5C a screen shot depicting one embodiment of an enumeration of a subset of the plurality of techniques;

FIG. 5D is a screen shot depicting an alternative embodiment of an enumeration of a subset of the plurality of techniques;

FIG. 5E is a screen shot depicting one embodiment of a resource associated with the enumerated subset of techniques;

FIG. 6A is a screen shot depicting one embodiment of a model;

FIG. 6B is a screen shot depicting one embodiment of a plurality of reporting components;

FIG. 6C is a screen shot depicting one embodiment of a report; and

FIG. 6D is a flow diagram depicting one embodiment of the steps taken in a method for assisting a financial services professional to tailor a presentation of information to a client through generation of customized reports.

### DETAILED DESCRIPTION OF THE INVENTION

The present invention relates to a method and system for determining an effect of a financial decision on a plurality of related entities. In one embodiment, a determination is made of an effect on each entity in a plurality of entities related to a first entity, responsive to an association of data with the first entity and to an identification of a relationship between the first entity and each entity in the plurality of entities. In some embodiments, a first entity is a client of a financial services professional seeking financial advice and assistance regarding topics such as the management, maintenance and transfer of wealth and assets. In these embodiments, the client may seek to understand the repercussions of financial transactions on people and entities associated with the client. The plurality of entities related to the first entity may include people or entities, and may include family members, certain non-family members, charitable organizations such as a private foundation, trusts, and closely held entities. An entity in the plurality of entities may be referred to as a stakeholder associated with a client.

In some embodiments, maximization of family wealth may be a primary goal of a client. In these embodiments, measuring the effect of a financial transaction on only the client is of little value. The present invention provides a method for capturing relationships of all family members via a graphical interface, which may be structured as a family tree, and all non-family members who may be affected by the planning decisions of the client. Accordingly, when an assumption is made in an attempt to identify an appropriate course of planning action, results of that assumption will automatically be reflected and displayed in the detailed information associated with entities in the plurality of entities related to the first entity, such as the balance sheet, cash flow and estate disposition projections of all stakeholders.

An embodiment of the present invention is applicable to a distributed networking environment where a remote machine may receive information from a user of a local machine across a network. Prior to discussing the specifics of the present invention, it may be helpful to discuss some of the network environments in which the illustrative embodiment of the present invention may be employed.

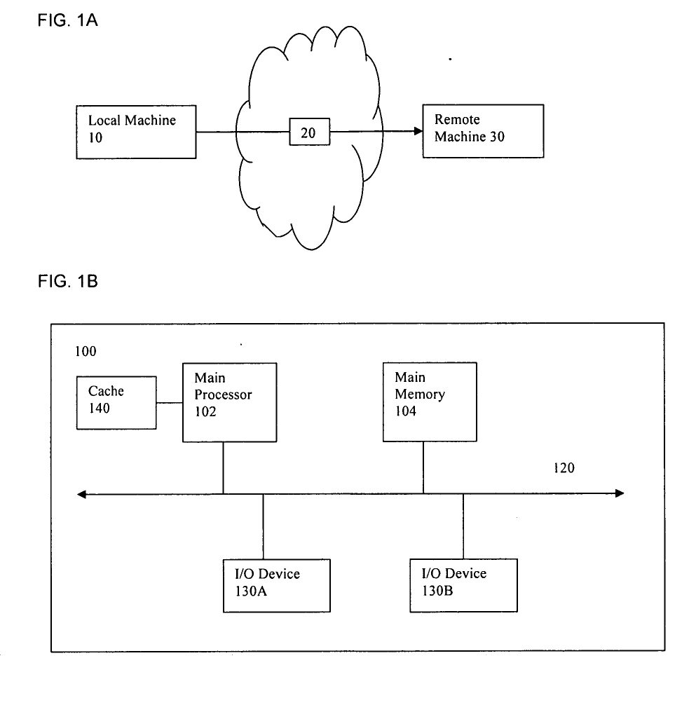

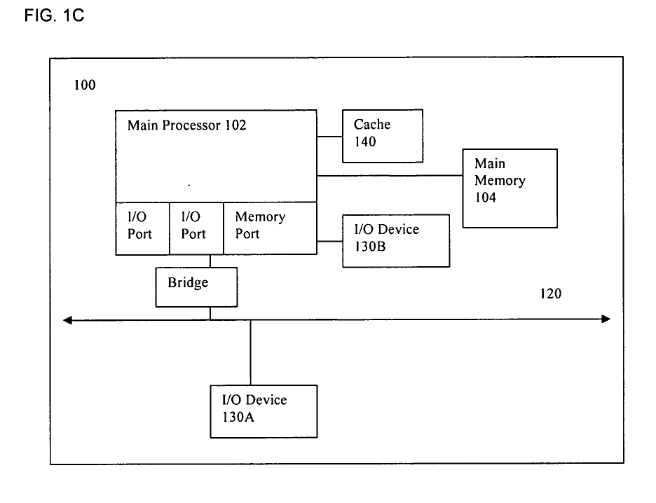

FIG. 1A is a block diagram of an environment suitable for practicing the illustrative embodiment of the present invention and in which a local machine communicates with a remote machine across a network. A user of a local machine 10 is able to connect to a remote machine, such as remote machine 30. A remote machine 30 may be referred to as a server, a file server, a web server, or a remote machine. The local machine 10 may also be referred to as a client node or an endpoint.

The communications link 20 over which local machine 10 and remote machine 30 communicate may be synchronous or asynchronous and may be a LAN connection, MAN (Medium-Area Network) connection, or a WAN connection. Additionally, communications link 20 may be a wireless link, such as an infrared channel or satellite band.

In one embodiment, a user of a local machine 10 communicates with remote machine 30 over a communications link 20 to execute software residing on remote machine 30 or to interact with software executing on remote machine 30. In another embodiment, a user of a local machine 10 uses the communications link 20 to interact with a web site hosted by remote machine 30. In some embodiments, data generated by an application program executing on remote machine 30 is stored on local machine 10. In one of these embodiments, the data is stored in an encrypted format. In other embodiments, the remote machine 30 resides on a private network. In one of these embodiments, the local machine 10 also resides on the private network.

In many embodiments, the remote machine 30 and the local machine 10 are provided as personal computer or computer servers, of the sort manufactured by Apple Computer, Inc., of Cupertino, Calif., International Business Machines of White Plains, N.Y., Hewlett-Packard Corporation of Palo Alto, Calif. or the Dell Corporation of Round Rock, Tex.

FIGS. 1B and 1C depict block diagrams of a typical computer 100 useful in those embodiments as the remote machine 30, or the local machine 10, 20. As shown in FIGS. 1B and 1C, each computer 100 includes a central processing unit 102, and a main memory unit 104. Each computer 100 may also include other optional elements, such as one or more input/output devices 130a-130n (generally referred to using reference numeral 130), and a cache memory 140 in communication with the central processing unit 102.

The central processing unit 102 is any logic circuitry that responds to and processes instructions fetched from the main memory unit 104. In many embodiments, the central processing unit is provided by a microprocessor unit, such as those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif.

Main memory unit 104 may be one or more memory chips capable of storing data and allowing any storage location to be directly accessed by the microprocessor 102, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 1B, the processor 102 communicates with main memory 104 via a system bus 120 (described in more detail below). FIG. 1C depicts an embodiment of a computer system 100 in which the processor communicates directly with main memory 104 via a memory port. For example, in FIG. 1C, the main memory 104 may be DRDRAM.

FIG. 1A and FIG. 1B depict embodiments in which the main processor 102 communicates directly with cache memory 140 via a secondary bus, sometimes referred to as a “backside” bus. In other embodiments, the main processor 102 communicates with cache memory 140 using the system bus 120. Cache memory 140 typically has a faster response time than main memory 104 and is typically provided by SRAM, BSRAM, or EDRAM.

In the embodiment shown in FIG. 1C, the processor 102 communicates with various I/O devices 130 via a local system bus 120. Various busses may be used to connect the central processing unit 102 to the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 102 may use an Advanced Graphics Port (AGP) to communicate with the display. FIG. 1C depicts an embodiment of a computer system 100 in which the main processor 102 communicates directly with I/O device 130b via HyperTransport, Rapid I/O, or InfiniBand. FIG. 1C also depicts an embodiment in which local busses and direct communication are mixed: the processor 102 communicates with I/O device 130a using a local interconnect bus while communicating with I/O device 130b directly.

A wide variety of I/O devices 130 may be present in the computer system 100. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 100 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif., and the iPod Shuffle line of devices manufactured by Apple Computer, Inc., of Cupertino, Calif.

In further embodiments, an I/O device 130 may be a bridge between the system bus 120 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIG. 1B and FIG. 1C typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

The local machine 10 may be any personal computer (e.g., a Macintosh computer or a computer based on processors such as 286, 386, 486, Pentium, Pentium II, Pentium III, Pentium IV, Pentium M, the Celeron, or the Xeon processor, all of which are manufactured by Intel Corporation of Mountain View, Calif.), Windows-based terminal, Network Computer, wireless device, information appliance, RISC Power PC, X-device, workstation, mini computer, main frame computer, personal digital assistant, or other computing device that has a windows-based desktop and sufficient persistent storage for executing a small, display presentation program. The display presentation program uses commands and data sent to it across communication channels to render a graphical display. Windows-oriented platforms supported by the local machine 10 can include, without limitation, WINDOWS 3.x, WINDOWS 95, WINDOWS 98, WINDOWS NT 3.51, WINDOWS NT 4.0, WINDOWS 2000, Windows 2003, WINDOWS CE, Windows XP, Windows vista, MAC/OS, Java, Linux, and UNIX. The local machine 10 can include a visual display device (e.g., a computer monitor), a data entry device (e.g., a keyboard), persistent or volatile storage (e.g., computer memory) for storing downloaded application programs, a processor, and a mouse. Execution of a small, display presentation program allows the local machine 10 to participate in a distributed computer system model (i.e., a server-based computing model).

For embodiments in which a local machine 10 is a mobile device, the device may be a JAVA-enabled cellular telephone, such as those manufactured by Motorola Corp. of Schaumburg, Ill., those manufactured by Kyocera of Kyoto, Japan, or those manufactured by Samsung Electronics Co., Ltd., of Seoul, Korea. In other embodiments in which the local machine 10 is mobile, it may be a personal digital assistant (PDA) operating under control of the PalmOS operating system, such as the devices manufactured by palmOne, Inc. of Milpitas, Calif. In further embodiments, the local machine 10 may be a personal digital assistant (PDA) operating under control of the PocketPC operating system, such as the iPAQ devices manufactured by Hewlett-Packard Corporation of Palo Alto, Calif., the devices manufactured by ViewSonic of Walnut, Calif., or the devices manufactured by Toshiba America, Inc. of New York, N.Y. In still other embodiments, the local machine 10 is a combination PDA/telephone device such as the Treo devices manufactured by palmOne, Inc. of Milpitas, Calif. In still further embodiments, the local machine 10 is a cellular telephone that operates under control of the PocketPC operating system, such as those manufactured by Motorola Corp.

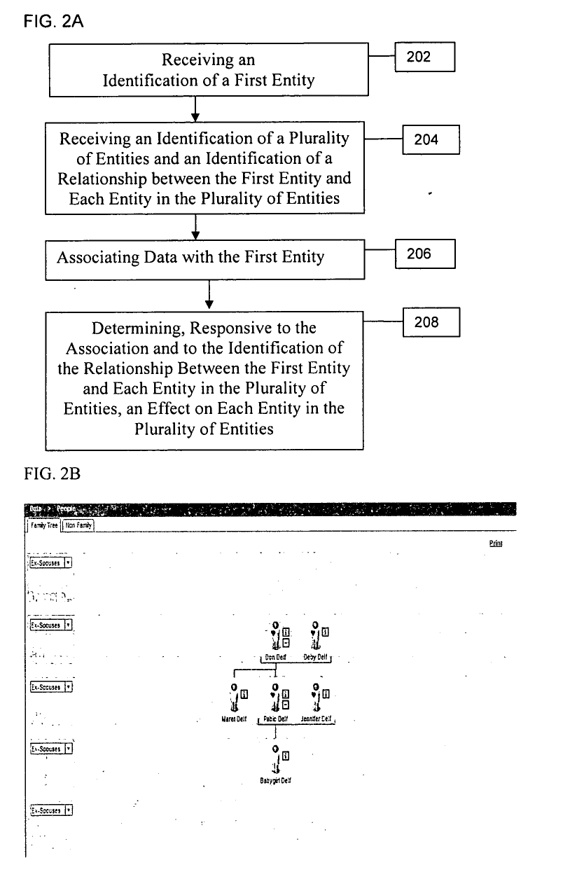

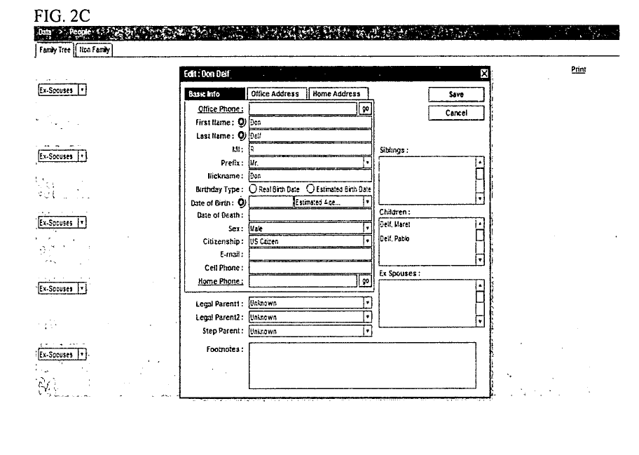

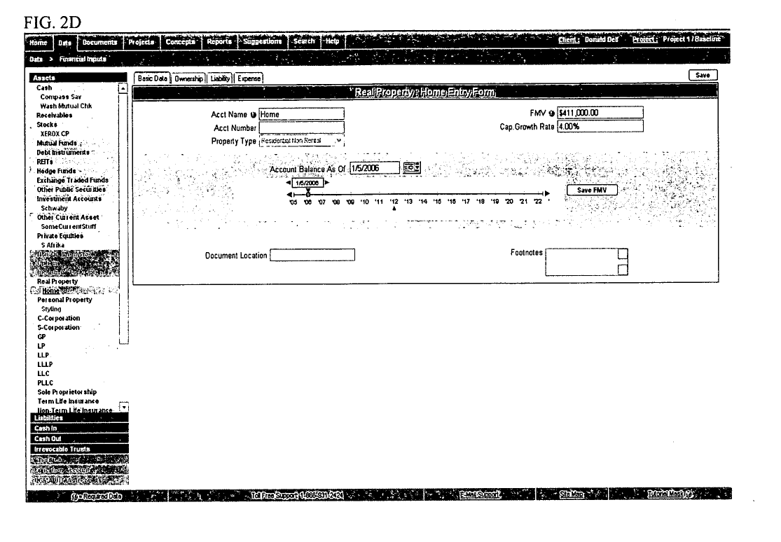

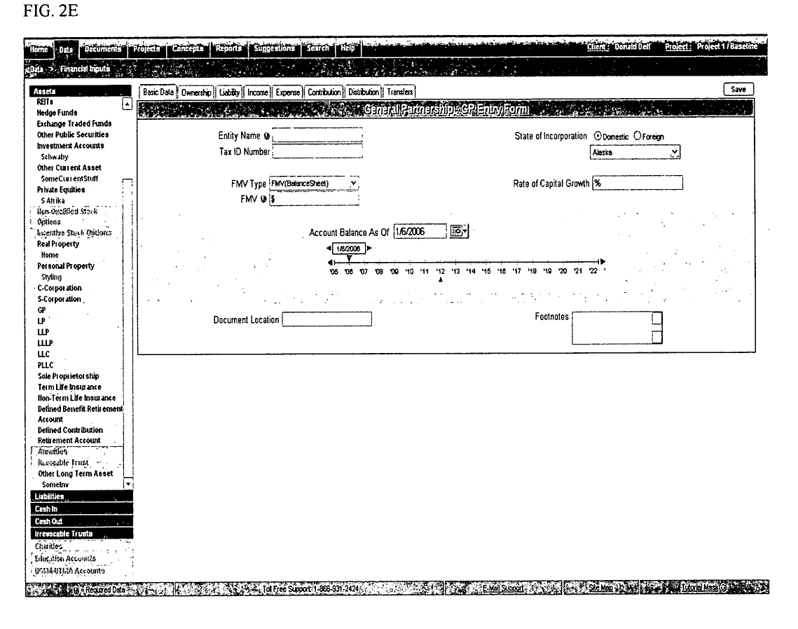

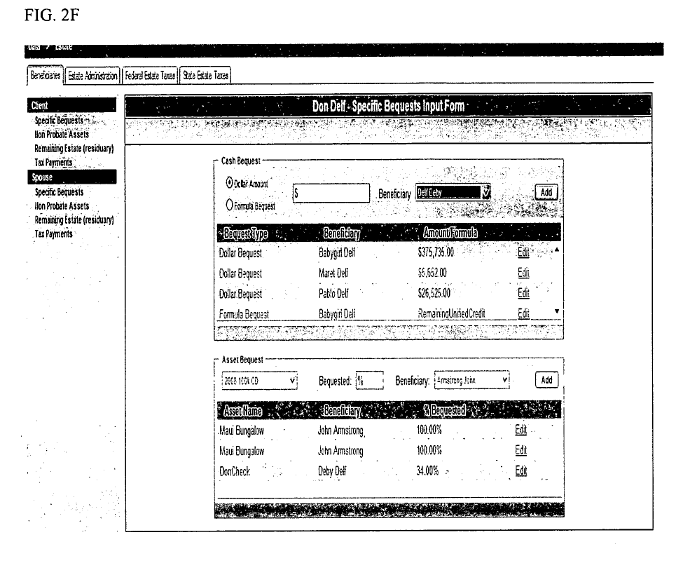

Referring now to FIG. 2A, a flow diagram depicts one embodiment of the steps taken in a method for determining an effect of a financial decision on a plurality of related entities. In brief overview, an identification of a first entity is received (step 202). An identification of a plurality of entities and an identification of a relationship between the first entity and each entity in the plurality of entities is received (step 204). Data is associated with the first entity (step 206). A determination is made of an effect on each entity in the plurality of entities, responsive to the association and to the identification of the relationship between the first entity and each entity in the plurality of entities (step 208).

Referring now to FIG. 2A, and in greater detail, an identification of a first entity is received (step 202). In one embodiment, an identification of a person may be received. In another embodiment, an identification of a legal entity may be received. In some embodiments, the first entity is a client of a financial services professional. In one embodiment, the identification is received in a transmission sent across a network. In another embodiment, a user interface is implemented to receive the identification. In still another embodiment, a user interface on a remote machine 30 receives the identification in a transmission across a network from a user of a local machine 10.

An identification of a plurality of entities and an identification of a relationship between the first entity and each entity in the plurality of entities is received (step 204). In one embodiment, an entity in the plurality of entities is a stakeholder in an asset associated with the first entity. In another embodiment, an entity in the plurality of entities is referred to as a stakeholder. In some embodiments, an identification of a familial relationship between an entity in the plurality of entities and the first entity is received. In one of these embodiments, personal identification information associated with the entity in the plurality of entities may be also received, including, but not limited to, date of birth, estimated age, life expectancy, citizenship and contact information. In another of these embodiments, an identification of a change in a relationship of affinity is received. In still another of these embodiments, an identification is received of a non-family member associated with the first entity who may have a financial relationship with the first entity.

In one embodiment, an entity in the plurality of entities is an asset owned by the first entity. In another embodiment, an entity in the plurality of entities is an asset in which the first entity has an interest. In some embodiments, an entity in the plurality of entities may be both an asset in which the first entity has an interest and a stakeholder. In one of these embodiments, the entity in the plurality of entities may, as a stakeholder, be impacted by actions of the first entity. In another of these embodiments, the first entity, having an interest in the stakeholder, may be impacted by actions of the first entity. In still another of these embodiments, financial data may be associated with either the stakeholder, the first entity, or both. In yet another of these embodiments, a model may be generated depicting effects on either the stakeholder or on the first entity or on both.

In other embodiments, an identification of a business relationship between an entity in the plurality of entities and the first entity is received. In one of these embodiments, an identification of an ownership interest of the first entity in an entity in the plurality of entities is received.

In some embodiments, a user interface is implemented to receive the identification. In one of these embodiments, a user interface on a remote machine 30 receives the identification in a transmission across a network from a user of a local machine 10.

Referring now to FIG. 2B, a screen shot depicts an embodiment in which a graphical representation is generated. In some embodiments, a graphical representation of the first entity and the plurality of entities is generated, responsive to receiving the identifications. In one of these embodiments, the graphical representation represents the first entity and the plurality of entities in a family tree structure.

Referring now to FIGS. 2C, 2D, and 2E, data is associated with the first entity (step 206). In FIG. 2C, a screen shot depicts one embodiment of a user interface receiving data associated with a first entity. In some embodiments, personal identification information associated with the first entity may be received, including, but not limited to, date of birth, estimated age, life expectancy, citizenship and contact information. In other embodiments, an identification of personal property is received. In still other embodiments, an identification of real property is received. In yet other embodiments, an identification of a financial asset owned by the first entity is received.

In FIG. 2D, a screen shot depicts another embodiment of a user interface receiving data associated with a first entity. Various types of financial data may be gathered, including information on various assets. Depicted in FIG. 2D is a personal residence having a current fair market value of $411,000 and appreciating at a rate of 4% per year. Future fair market values may also be scheduled at future dates or events. Associated with the basic asset information are tabs providing additional information, including ownership information, associated liabilities having the asset as collateral and any expenses. For example, with the personal residence, a client could also provide information about the mortgage, real estate taxes, homeowner's insurance, or maintenance, in order to accurately project the effect of owning the home on the client's future balance sheets and cash flow statements.

In some embodiments, financial data is associated with the first entity. In one of these embodiments, financial data includes, but is not limited to, detailed information relating to bank accounts, loans, stocks, mutual funds, debt instruments, trusts, funds, public securities, investment accounts, liabilities, education accounts, retirement accounts, annuities, pension plans and life insurance. In another of these embodiments, the financial data includes information relating to closely-held business entities including but not limited to partnerships and corporations.

Referring now to FIG. 2E, a screen shot depicts one embodiment of a user interface receiving financial data associated with the first entity. FIG. 2E depicts one embodiment of an input form, in this case an input form for a general partnership. In some embodiments, the user interface receives information from a client for association with the first entity as part of a process for building a personal balance sheet for the client. In one embodiment, the client creates the partnership and indicates what percentage is owned by the client. The partnership is added as an entity in the plurality of entities. Owners may be identified under an ownership table associated with the partnership entity. Owners may include family members of the client, trusts, or other business entities. In some embodiments, other entities in the plurality of entities, such as family members of the first entity, may be owners of the partnership. In one of these embodiments, the entities in the plurality of entities related to the client (i.e., family members) are also entities in a second plurality of entities related to the entity representing the partnership. Additional data may be associated for the partnership, such as providing all future income and expense detail in addition to appreciation for projection of future value of the partnership. Similarly, all future contributions and distributions may be scheduled.

In some embodiments, transactions such as future contributions and distributions of the partnership, may affect all owners of the partnership—the entities in various pluralities of interrelated entities. In one of these embodiments, all owners may make contributions and assets will leave their balance sheet and be added to the partnership's balance sheet. In another of these embodiments, distributions will be made from the partnership and assets will leave the partnership's balance sheet and be added to the owner's balance sheet. In still another of these embodiments, transfers, including both gifts and sales, may be scheduled for each of the owner's partnership interests. Thus, if a client wants to gradually, through a series of gifts, transfer ownership of his partnership interests this can be modeled and the effects shown on his children's balance sheets.

In other embodiments, estate planning information is associated with the first entity. In one of these embodiments, estate planning information includes, but is not limited to, details regarding beneficiaries, specific bequests, non probate assets, disposition of assets, financial institution representatives, personal representatives, individual representatives, fees paid to representatives, estate administration fees, powers of attorney, health care proxies, guardians and living wills. In FIG. 2F, a screen shot depicts one embodiment of a user interface receiving estate planning data associated with the first entity.

In some embodiments, the data associated with the first entity represents a type of relationship between the first entity and an entity in the plurality of entities. In one of these embodiments, the type of relationship associated with the first entity is selected responsive to the received identification of the relationship between the first entity and the entity in the plurality of entities. In another of these embodiments, the data associated with the first entity indicates a familial relationship between the first entity and the entity in the plurality of entities. In still another of these embodiments, the data associated with the first entity indicates a business relationship between the first entity and the entity in the plurality of entities. In yet another of these embodiments, the data associated with the first entity indicates an ownership interest held by the first entity in the entity in the plurality of entities.

In some embodiments, data is associated with an entity in the plurality of entities related to the first entity. In one of these embodiments, financial data is associated with the entity in the plurality of entities. In another of these embodiments, personal data is associated with the entity in the plurality of entities. In still another of these embodiments, any of the types of data described above may be associated with the entity in the plurality of entities.

In some embodiments, the data associated with the first entity comprises a description of a transaction. In one of these embodiments, the data associated with the first entity indicates a transfer of an asset from the first entity to an entity in the plurality of entities. The transfer of the asset may include, without limitation, a gift, a bequest, a tax, a payment, a donation, or other transfers from the first entity to the entity in the plurality of entities. The transfer of the asset may affect the financial status or obligations of the entity in the plurality of entities, or of the first entity. In another of these embodiments, the transaction has already occurred. In still another of these embodiments, the transaction is scheduled to occur at a point in time after the data is associated with the first entity. The point of time may be a date, may be the occurrence of an event, or the occurrence of a sequence of events. In yet another of these embodiments, the transaction is not scheduled to occur at a particular point in time. In other embodiments, a modification is made to data associated with the first entity. In one of these embodiments, the modification changes a transaction. In another of these embodiments, the modification adds a new entity to the plurality of entities associated with the first entity. In still another of these embodiments, the modification changes a relationship type or status between the first entity and an entity in the plurality of entities.

In some embodiments, a first entity is a client of a financial services professional seeking to understand the repercussions of financial transactions on people and entities associated with the client. The present invention provides a method for capturing relationships of all family members via a graphical interface, which may be structured as a family tree, and all non-family members who may be affected by the planning decisions of the client.

Referring back to FIG. 2A, a determination is made of an effect on each entity in the plurality of entities, responsive to the association and to the identification of the relationship between the first entity and each entity in the plurality of entities (step 208). In one embodiment, the determination of the effect on each entity in the plurality of entities is presented to the client to assist in the planning decisions of the client. In another embodiment, a determination of an effect on the client is made responsive to the association of data with the client and to the identification of the relationship between the first entity and each entity in the plurality of entities. In still other embodiments, a determination is made of a projected effect on each entity in the plurality of entities, responsive to the association and to the identification of the relationship between the first entity and each entity in the plurality of entities, a projected effect on each entity in the plurality of entities.

In some embodiments, the determination of the effect on the first entity is represented to the first entity through a balance sheet generated responsive to the association of data with the first entity. In other embodiments, the determination of the effect on an entity in the plurality of entities is represented to the first entity through a balance sheet associated with the entity in the plurality of entities generated responsive to the association of data with the first entity.

The present invention also relates to a system for determining an effect of a financial decision on a plurality of related entities. In one embodiment, the system includes a means for receiving an identification of a first entity; a means for receiving an identification of a plurality of entities and an identification of a relationship between the first entity and each entity in the plurality of entities; a means for associating data with the first entity; and a means for determining, responsive to the association and to the identification of the relationship between the first entity and each entity in the plurality of entities, an effect on each entity in the plurality of entities.

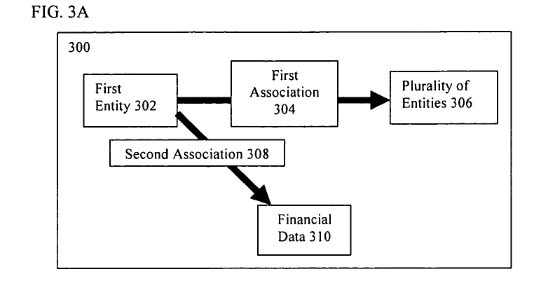

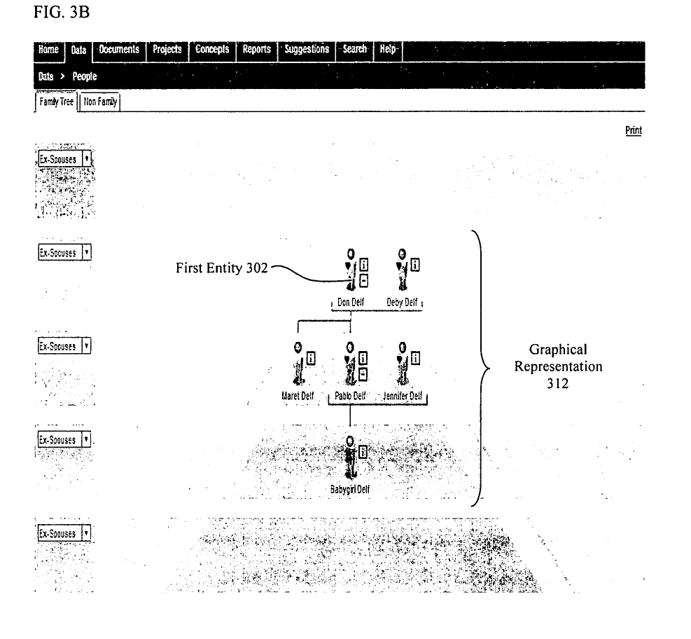

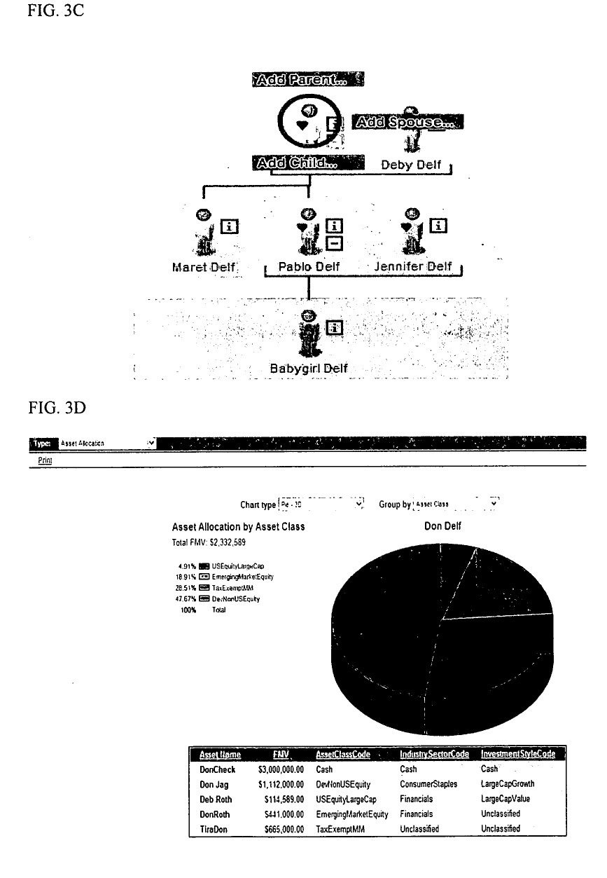

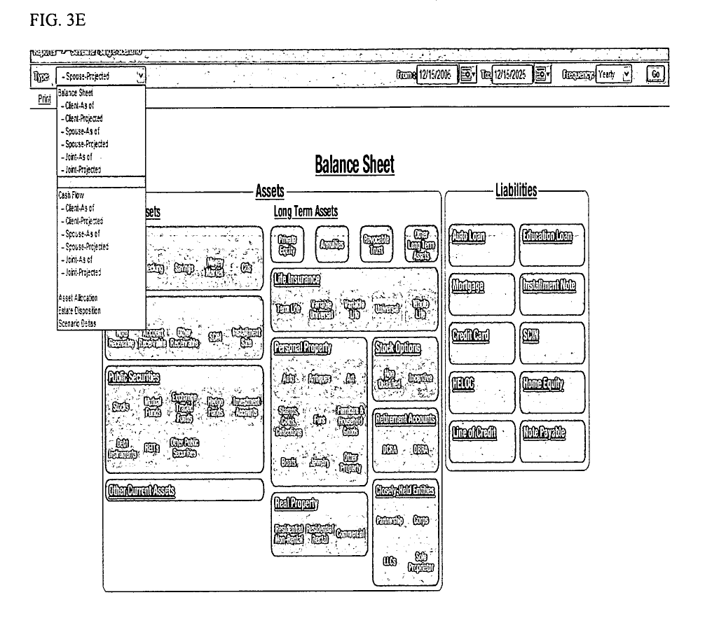

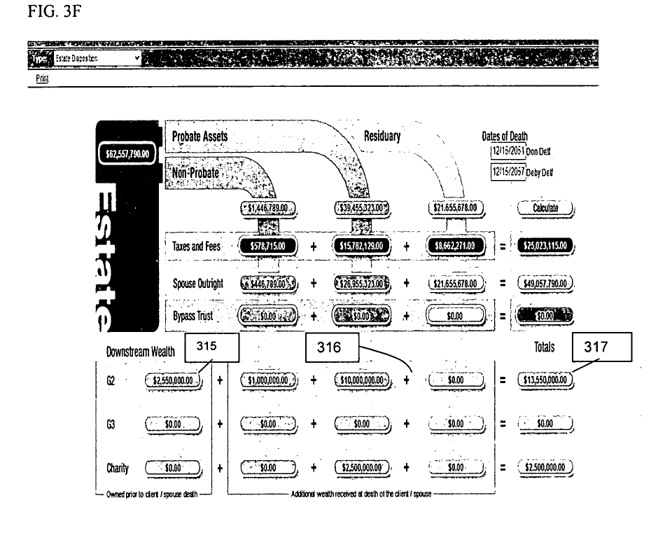

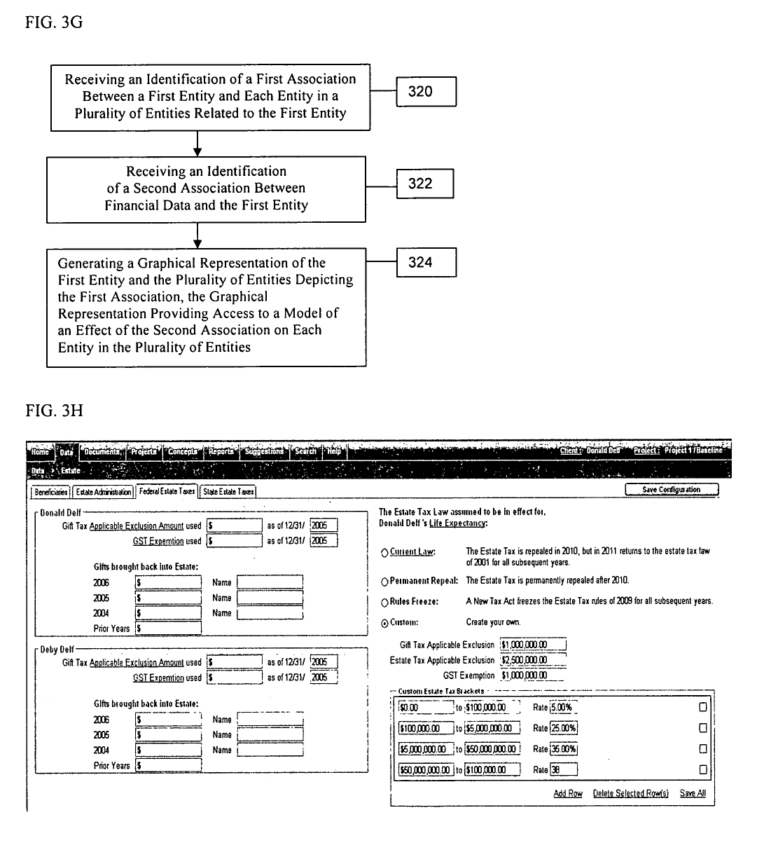

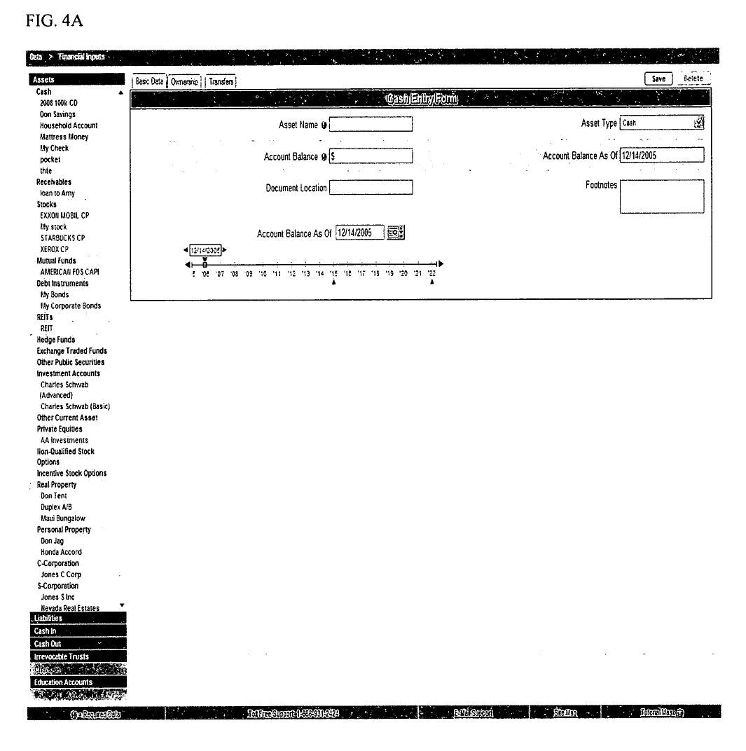

Referring now to FIG. 3A and FIG. 3B, a block diagram and a screen shot depict one embodiment of a system for determining an effect of a financial decision on a plurality of related entities. In FIG. 3A, a block diagram depicting one embodiment of the system includes a first entity 302, a first association 304, a plurality of entities 306, a second association 308, and financial data 310. In brief overview, the first association 304 is between the first entity 302 and each entity in a plurality of entities 306 related to the first entity 302. The second association is between financial data 310 and the first entity 302. In FIG. 3B, a screen shot depicts one embodiment of a graphical representation 312. The graphical representation 312 represents the first entity and the plurality of entities, depicts the first association, and provides access to a model of an effect of the second association on each entity in the plurality of entities.

The first association 304 is an association between the first entity 302 and each entity in a plurality of entities 306 related to the first entity 302. In one embodiment, the first association 304 is received across a network. In another embodiment, a user transmits the first association 304 via a user interface such as the user interface depicted in FIG. 3B. In still another embodiment, the first association may be an identification of a relationship between the first entity and an associated entity. Other embodiments of the first association include the embodiments described above, in connection with FIG. 2A.

The second association is an association between financial data 310 and the first entity 302. In one embodiment, the second association may be an identification of a financial transaction. In another embodiment, the second association may be an identification of a financial asset. In still another embodiment, the second association may be an identification of an ownership interest held by the first entity in an entity in the plurality of entities. In some embodiments, financial data is associated with an entity in the plurality of entities. Other embodiments of the first association include the embodiments described above, in connection with FIG. 2C, FIG. 2D, and FIG. 2E.

The graphical representation 312 represents the first entity and the plurality of entities, depicts the first association, and provides access to a model of an effect of the second association on each entity in the plurality of entities. In one embodiment, depicted in the screen shot in FIG. 3B, the graphical representation is a depiction of a family tree. In another embodiment, the family tree depicts the first entity and the plurality of entities related to the first entity. In still another embodiment, the depiction of the first entity and the plurality of entities as nodes on the tree and the arrangement of the graphical representation of each entity on the tree provides a depiction of the relationship between the entities and of the first association.

In some embodiments, representation of the first entity and the plurality of entities in a family tree provides a structure associating all relevant planning persons and providing access to financial modeling for all people and entities. In one of these embodiments, the family tree is an interactive family tree, with each node in the tree providing a link to additional information associated with the node. In an embodiment depicted by FIG. 3B, a plurality of graphical representations depict the first entity 302 at the root of the tree. A user may select a graphical representation in the plurality of graphical representations. The selection of the graphical representation by the user transmits a request for additional information. In some embodiments, a user may select an entity in the plurality of entities by selecting a graphical representation of a node in the tree. In one of these embodiments, the user may request generation of a graphical representation of the selected entity in the plurality of entities and of a second plurality of entities related to the selected entities. In another of these embodiments, the user may use the selection of the entity in the plurality of entities to change the entity at the root of the family tree.

In one embodiment, depicted in FIG. 3C, by selecting the graphical representation depicting a person, a user may transmit additional information for association with the first entity. In another embodiment, selection of a graphical representation, such as the depiction of the letter “I” to the right of the first entity 302, enables a user to enter personal information for association with the first entity. In another embodiment, selection of the tabs at the top of the user interface enables a user to associate additional financial data with the first entity.

In one embodiment, the graphical representation 312 provides access to a description of the second association. Referring now to FIG. 3D, a screen shot depicts one embodiment of a depiction of the second association between financial data and the first entity. In this embodiment, assets have been associated with the first entity. The depiction of the second association represents asset allocation by asset class. In some embodiments, the second association may associate financial inputs, estate details, or asset allocation information with the first entity.

Referring now to FIG. 3E, a screen shot depicts one embodiment of a reporting component in a graphical representation providing access to a model of an effect of the second association. In some embodiments, the graphical representation provides access to a model of an effect of the second association on the first entity. In other embodiments, the graphical representation provides access to a model of an effect of the second association on an entity in the plurality of entities. In still other embodiments, the graphical representation includes a reporting component. In one of these embodiments, the reporting component provides access to a model of an effect of the second association on either the first entity or an entity in the plurality of entities. In another of these embodiments, the reporting component generates a customized report of the model. In the embodiment depicted by FIG. 3E, a balance sheet is provided for an entity in the plurality of entities related to the first entity. In this embodiment, the balance sheet is provided for a spouse of a client. By selecting an entry in the balance sheet, a user may access a model of an effect of an association of data with the first entity on an entity in the plurality of entities, or on the first entity or on multiple entities. In the embodiment depicted by FIG. 3E, a drop-down menu is provided in a user interface to enable a user to transmit an identification of an entity via the user interface. In one embodiment, upon receipt of the identification of the entity, a balance sheet is generated for the identified entity. In another embodiment, upon receipt of the identification of the entity, a balance sheet for the identified entity is presented to the user. In still another embodiment, an interactive balance sheet is presented.

In some embodiments, where an interactive balance sheet is presented upon receipt of an identification of an entity, the elements within the balance sheet may be selected to indicate a request for access to a model of an effect on an identified entity. In one of these embodiments, a reporting component provides access to the interactive balance sheet and to the model of the effect on the identified entity. In an embodiment such as the one depicted in FIG. 3E, the balance sheet may provide access to a model of an effect on one of a plurality of assets or liabilities associated with an identified entity.

Referring now to FIG. 3F, a screen shot depicts one embodiment of a model of an effect on an entity. In one embodiment, the model is provided responsive to receipt, by a graphical representation such as an interactive family tree or an interactive balance sheet, of a request for access to the model. In the embodiment depicted by FIG. 3F, an effect on a spouse is depicted for a spouse of a client. The effect shown is an amount transferred to the spouse given a particular estate planning decision.

FIG. 3F also depicts an effect on a subset of the plurality of entities related to the first entity. In FIG. 3F, a subset of the plurality of entities are grouped by their relationship to the first entity and listed by generation (G2, G3, etc.). The amount of wealth accumulated by each generation is listed in column 315, an amount of money transferred to entities in the generation as a result of a transaction taken by the first entity is listed in column 316, and a sum of the two columns is provided in column 317. For each item in a column, a link may be provided to a user allowing the user to access financial data relied upon in determining the data shown.

Referring now to FIG. 3G, a flow diagram depicts one embodiment of the steps taken in a method for determining an effect of a financial decision on a plurality of related entities. In brief overview, an identification is received of a first association between a first entity and each entity in a plurality of entities related to the first entity (step 320). An identification is received of a second association between financial data and the first entity (step 322). A graphical representation is generated of the first entity and the plurality of entities depicting the first association, the graphical representation providing access to a model of an effect of the second association on each entity in the plurality of entities (step 324).

An identification is received of a first association between a first entity and each entity in a plurality of entities related to the first entity (step 320). In one embodiment, an identification of a familial relationship between an entity in the plurality of entities and the first entity is received. In another embodiment, an identification of a business relationship between an entity in the plurality of entities and the first entity is received. In still another embodiment, an identification of a characteristic associated with an entity in the plurality of entities is received. The identification of the characteristic may include, without limitation, an indication of marital status, residence, citizenship, income, and occupation.

Referring ahead to FIG. 3H, a screen shot depicts one embodiment of a user interface enabling a user to customize data associated with an entity in the plurality of entities. In some embodiments, an identification of a law applying to a characteristic associated with an entity in the plurality of entities is received. Receiving the identification enables modeling of the law on the characteristic. Receiving the identification further enables a user to model an effect responsive to a particular law. For example, effects of income tax rates that may vary from state to state may be modeled. In some embodiments, the identification may indicate a tax code to apply to the entity, responsive to the characteristic. As depicted in FIG. 3H, a user interface may be provided allowing customization of a law to be applied when calculating estate tax for projections. The user may provide a different law for different scenarios or generate various customized derivations of an existing law.

Referring back to FIG. 3G, an identification is received of a second association between financial data and the first entity (step 322). In one embodiment, the received identification indicates an association between financial data and an entity in the plurality of entities related to the first entity. In another embodiment, an identification is received indicating a modification to be made to the second association between financial data and the first entity. In still another embodiment, the identification is received indicating a modification to be made to an association between financial data and an entity in the plurality of entities.

In some embodiments, the modification may alter an existing asset transfer. In one of these embodiments, fair market value of the asset may be altered. In another of these embodiments, a capital growth rate of an asset may be altered, i.e., to reflect appreciation. In other embodiments, the modification may schedule a previously unscheduled asset transfer. In still other embodiments, the modification may alter a status such as marital status, residential status, or citizenship status. In yet another embodiment, the modification may enable a user to model an effect responsive to a prediction of the user associated with a change to a law.

In one embodiment, the identification of the second association results in a generation of a balance sheet associated with the first entity and reflecting the second association. In another embodiment, the identification of the second association results in a generation of a balance sheet associated with an entity in the plurality of entities and reflecting an effect of the second association. In yet another embodiment, the identification of the second association results in a generation of an interactive balance sheet as described above in connection with FIG. 3E and FIG. 3F.

A graphical representation is generated of the first entity and the plurality of entities depicting the first association, the graphical representation providing access to a model of an effect of the second association on each entity in the plurality of entities (step 324). In one embodiment, the graphical representation depicts the second association. In another embodiment, the graphical representation depicts a characteristic associated with an entity in the plurality of entities. In yet another embodiment, the graphical representation provides access to a model of an effect of the second association on the first entity.

In one embodiment, the graphical representation provides access to a model of an effect on the first entity of an association between financial data and an entity in the plurality of entities. In another embodiment, the graphical representation provides access to a model of an effect on the first entity of an association between the first entity and an entity in the plurality of entities. In still another embodiment, the graphical representation provides access to a model of an effect of a law on each entity in the plurality of entities.

In one embodiment, the graphical representation provides access to a projection of an effect of the second association on each entity in the plurality of entities. In another embodiment, the graphical representation provides access to a projection of an effect of the second association on the first entity. In one embodiment, the graphical representation provides access to a projection of an effect of a law on each entity in the plurality of entities.

In one embodiment, the graphical representation provides access to a model of an effect of the second association on a characteristic associated with an entity in the plurality of entities. In another embodiment, the graphical representation provides access to a model of an effect of the second association on a tax owed by an entity in the plurality of entities. The tax may include income tax, estate tax, gift tax, or generation skipping transfer tax. In still another embodiment, the graphical representation provides access to a model of an effect of the second association on a generation skipping transfer tax owed by an entity in the plurality of entities. In some embodiments, the graphical representation provides access to a model of an effect of a customized characteristic generated by a user on the second association on an entity in the plurality of entities.

In one embodiment, the graphical representation depicts a family tree. In another embodiment, the graphical representation provides access to a model of an effect of the second association responsive to receiving a selection of an entity in the plurality of entities depicted by the graphical representation. In still another embodiment, the graphical representation includes a reporting component, the reporting component providing access to the model of the effect of the second association on each entity in the plurality of entities.

The present invention further relates to a system for assisting a financial services professional to tailor a presentation of information to a client including a graphical representation, an identification of a plurality of transactions, and a modeling component. In an application service provider model, the system enables a financial services professional to enter information into a user interface and transmit the entered information across a network. The financial service professional may access the user interface across a network.

Referring back to FIG. 3B, a screen shot depicts one embodiment of a graphical representation of a first entity and a plurality of entities related to the first entity. The graphical representation depicts a first association between the first entity and each entity in the plurality of entities. The graphical representation depicts a second association between the first entity and data associated with the first entity. The graphical representation provides access to a model of an effect of the second association on each entity in the plurality of entities.

In one embodiment, the graphical representation is a depiction of a family tree. In another embodiment, the family tree depicts the first entity and each entity in the plurality of entities related to the first entity. Other embodiments of the graphical representation include those described above in connection with FIG. 3A through FIG. 3G.

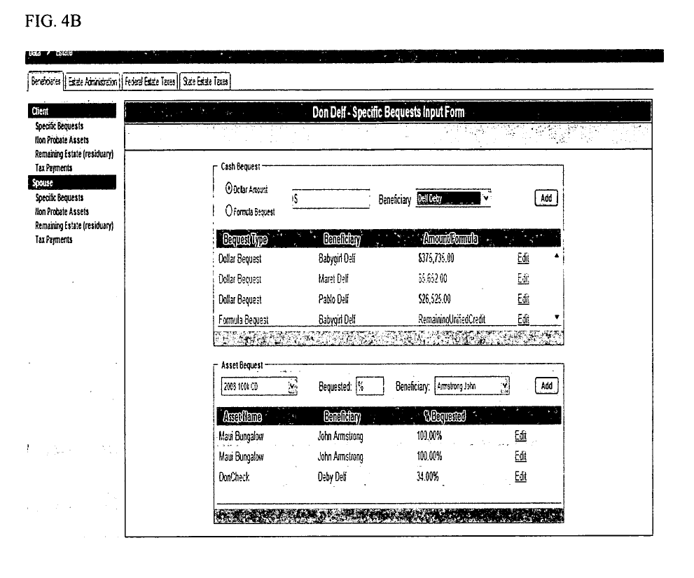

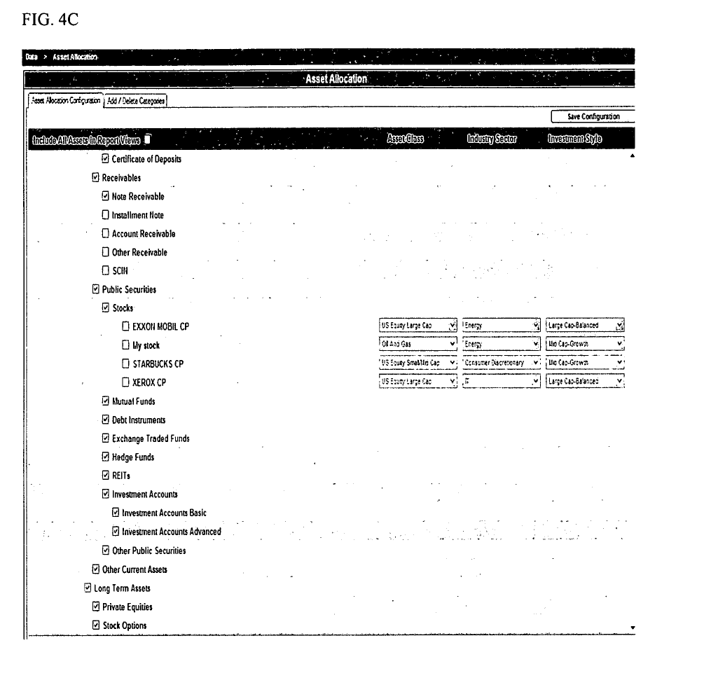

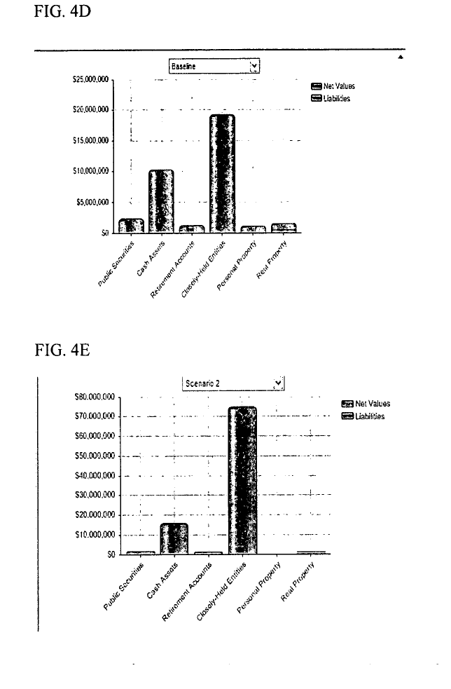

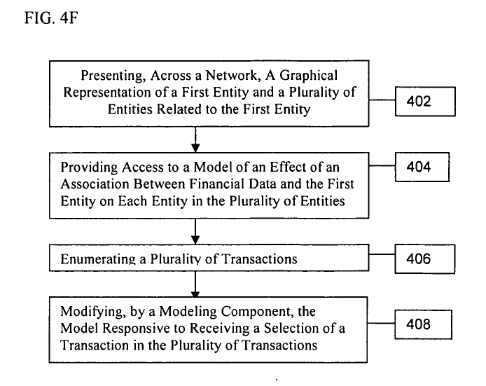

Referring now to FIG. 4A, FIG. 4B, and FIG. 4C, screen shots depict some embodiments of an identification of a plurality of transactions. In FIG. 4A, a screen shot depicts one embodiment of an identification of a plurality of transactions relating to financial data. In one embodiment, the transactions include modifications to ownership and to transfers. FIG. 4B depicts one embodiment of an identification of a plurality of transactions relating to estate planning decisions. In one embodiment, the transactions include bequests, administration, and transactions associated with the payment of federal and state estate taxes. In FIG. 4C, a screen shot depicts one embodiment of an identification of a plurality of transactions relating to asset allocation. In this embodiment, the transactions include the allocation of assets to various categories including, but not limited to, cash, receivables, public securities, private equities, stock options, real property, personal property, closely-held entities, life insurance, annuities, retirement accounts, and revocable trusts.

In some embodiments, the identification of the plurality of transactions may include an enumeration of at least one transaction modifying the second association. In one of these embodiments, the at least one transaction may modify a type of financial data associated with the first entity. In another of these embodiments, the at least one transaction may remove an association between a type of financial data and the first entity. In still another of these embodiments, the at least one transaction may modify a classification of the type of financial data associated with the first entity.

In other embodiments, the identification of the plurality of transactions may include an enumeration of at least one transaction modifying the effect of the second association on an entity in the plurality of entities. In one of these embodiments, the modification of the effect may result in an association of a new obligation or right with the entity in the plurality of entities. In another of these embodiments, the modification of the effect may result in an increase in an existing right or obligation associated with the entity in the plurality of entities. In still another of these embodiments, the modification of the effect may result in a removal of or decrease in an existing right or obligation associated with the entity in the plurality of entities.

In still other embodiments, the identification of the plurality of transactions may include an enumeration of at least one transaction modifying an entity in the plurality of entities related to the first entity. In one of these embodiments, the transaction may add an entity to the plurality of entities. In another of these embodiments, the transaction may modify a status of a relationship between an entity in the plurality of entities, for example, from non-family to family, or from family to non-family. In still another of these embodiments, the transaction may modify a status of an entity in the plurality of entities, changing, for example, a marital status or corporate structure.

In some embodiments, the graphical representation includes a reporting component. In other embodiments, the graphical representation provides access to a reporting component. In still other embodiments, the reporting component provides access to a summary, model, or projection of an effect on an entity in the plurality of entities, or on the first entity. In yet other embodiments, the reporting component generates a customized report descriptive of the model of the effect of the second association on each entity in the plurality of entities. In one of these embodiments, the reporting component generates at least one report responsive to a request for the report. In another of these embodiments, the reporting component generates at least one report responsive to a selection of a transaction. In still another of these embodiments, the reporting component generates at least one report responsive to a modification of a model of an effect of an association on an entity. In yet another of these embodiments, a report generated responsive to a modification by a modeling component comprises a comparison between a model and a modification of a model.

Referring now to FIG. 4D and FIG. 4E, screen shots depict an embodiment in which a modeling component modifies a model responsive to receiving a selection of a transaction in the plurality of transactions. As discussed above, in one embodiment, the graphical representation provides access to a model of an effect on either the first entity or an entity in the plurality of entities related to the first entity. In some embodiments, the graphical representation includes, or provides access to a reporting component. In some embodiments, the graphical representation includes, or provides access to a modeling component. In other embodiments, a reporting component includes, or provides access to, a modeling component.

As depicted in FIG. 4D, a modeling component may provide access to a model of an effect on an entity in the plurality of entities, or on the first entity, or on both the first entity and an entity in the plurality of entities. In the embodiment depicted in FIG. 4D, a model is provided of the value of financial data associated with the first entity and an entity in the plurality of entities, in this embodiment, a client and a spouse of the client. As depicted in FIG. 4E, a modeling component may also present a model of a modification to the associations between the first entity and financial data and the first entity and the plurality of entities. In some embodiments, the modeling component modifies the existing model to depict the modification to the association. In other embodiments, the modeling component generates a second model depicting the modifications to the existing model.

In the embodiment depicted in FIG. 4E, a screen shot depicts a model provided of a scenario in which associations between financial data and the first entity are modified. In some embodiments, a scenario describes a possible course of planning action and a baseline scenario describes an existing state of planning associated with the first entity. In one of these embodiments, after creation of a scenario, the scenario may be compared to the baseline scenario. In another of these embodiments, a comparison of scenarios assists a financial services professional and a client in determining a course of planning action. In still another embodiment, a comparison of scenarios assists in the measurement of an effect of a course of planning action. In yet another of these embodiments, a comparison of scenarios demonstrates added value provided by implementation of a particular course of planning action.

Referring now to FIG. 4F, a flow diagram depicts one embodiment of the steps taken in a method for assisting a financial services professional to tailor a presentation of information to a client. In brief overview, a graphical representation of a first entity and a plurality of entities related to the first entity is presented across a network (step 402). Embodiments of the graphical representation include those described above in connection with FIGS. 2A-3G. Access is provided to a model of an effect of an association between financial data and the first entity on each entity in the plurality of entities (step 404). A plurality of transaction is enumerated (step 406). A modeling component modifies the model responsive to receiving a selection of a transaction in the plurality of transactions (step 408).

Access is provided to a model of an effect of an association between financial data and the first entity on each entity in the plurality of entities (step 404). In one embodiment, access is also provided to the model of the effect of the association between financial data and the first entity on the first entity. In another embodiment, access is provided to the model across a network. In still another embodiment, access is provided to a user interface depicting the model across a network. In some embodiments, a user receiving access to a model selects from the graphical representation an entity in the plurality of entities, or selects the first entity. In other embodiments, the user selecting an entity from the graphical representation requests access to a model of information associated with the entity by transmitting the selection across a network. In still other embodiments, the user selecting an entity from the graphical representation is provided with access to a model of an effect of an association of data with the first entity on the selected entity.

A plurality of transactions is enumerated (step 406). In one embodiment, the plurality of transactions is enumerated across a network. In some embodiments, the transactions have the effect of modifying an existing association between financial data and the first entity. In other embodiments, the transactions have the effect of generating a new association between financial data and the first entity. In still other embodiments, the transactions have the effect of generating a new asset transfer or bequest or modifying an existing asset transfer or bequest. In one of these embodiments, an entity in the plurality of entities that is identified as a recipient of a new transfer or bequest may be selected from the graphical representation of the plurality of entities.

A modeling component modifies the model responsive to receiving a selection of a transaction in the plurality of transactions (step 408). In one embodiment, the selection of the transaction is received across a network. In another embodiment, a user interface is implemented to receive the selection of the transaction across a network.

In one embodiment, the modeling component modifies the model responsive to a modification made by execution of a transaction in the plurality of transactions. In another embodiment, the modeling component modifies the model responsive to a projection of a modification associated with a transaction in the plurality of transactions. In still another embodiment, the modeling component generates a second model depicting a scenario in which the selected transaction is executed. In yet another embodiment, the modeling component generates a second model projecting a series of effects in a scenario in which the selected transaction is executed.

In some embodiments, the modeling component generates a second model, the second model representing a modification to the model occurring responsive to a selection of a transaction in the plurality of transactions. In one of these embodiments, the second model may be displayed to a user beside the model. In another of these embodiments, an indication is provided of a modification in the second model. For example, differences between the model and the second model may be highlighted.

In some embodiments, the modeling component modifies the model responsive to financial data associated with an entity in the plurality of entities. In other embodiments, the modeling component modifies the model responsive to financial data associated with the first entity. In still other embodiments, access is provided to financial data relied upon in modifying the model. In yet other embodiments, access may be provided to financial data and assumptions associated with the financial data relied upon in generating the model and the second model.

The present invention further relates to a method for enumerating available resources to improve an analysis of a client and an identification of client needs by a financial services professional. A client may have specific goals or objectives when meeting with a financial services professional. However, clients may not be aware of the tools needed to achieve those objectives or of topics related to those goals or objectives. In some instances, a client may not have goals or objectives or know how to accomplish them. Resources are available to the financial services professional to enable them to assist clients. However, resources may be so numerous that the financial services professional is not aware of all of the resources. In some instances, a financial services professional may become proficient in the use of certain planning techniques and accompanying resources to the exclusion of other valuable and relevant techniques and resources. In one embodiment of the present invention, tools are provided to assist the financial services professional identify the goals and objectives of clients and access relevant tools and resources.

In some embodiments, available resources contain practical and technical information used by financial services professionals to sell client planning projects, educate clients and staff, design and implement comprehensive wealth and tax planning for high net worth individuals. In other embodiments, available resources include various tools, techniques, entities, strategies, and financial transactions that act as components of a comprehensive plan. These resources may also be presented for a client's education and consideration, with the goal of eliminating those of no interest or application to the needs of a particular client.

In still other embodiments, available resources may comprise selling, education, or reference tools that “are one click away.” Motivating and educating clients may be achieved by following their thought processes and by answering their questions as they occur to them. These resources may facilitate that goal.

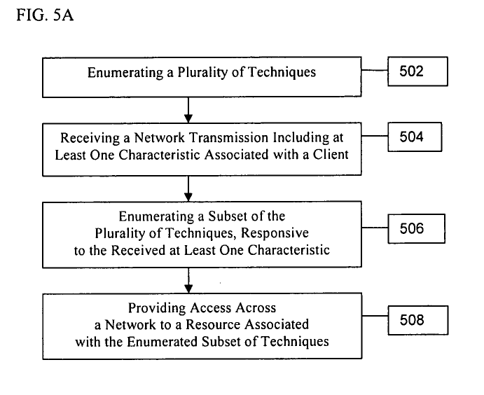

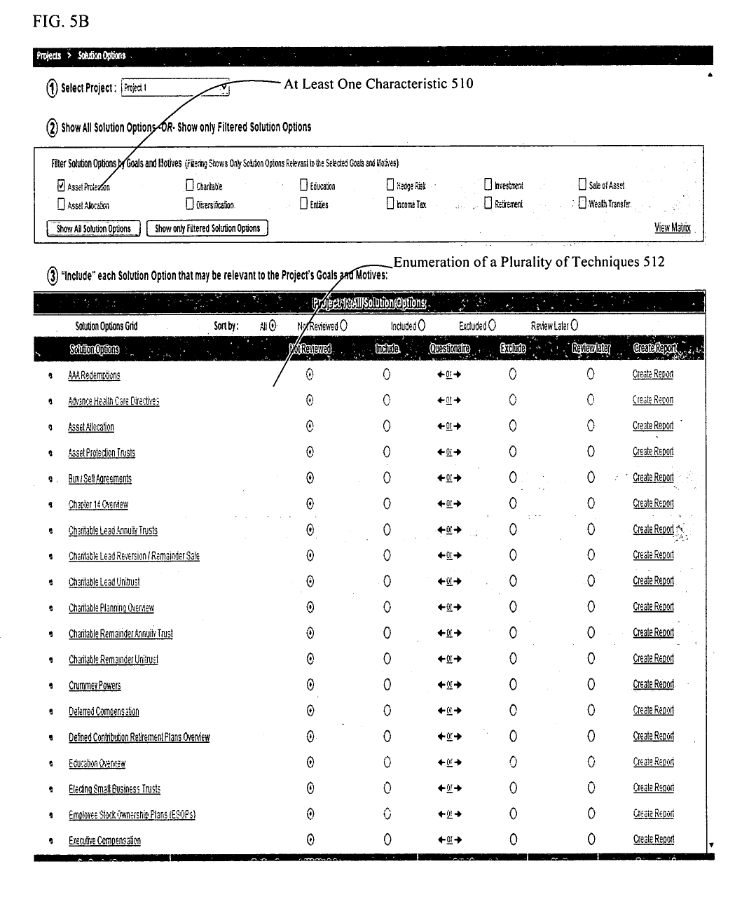

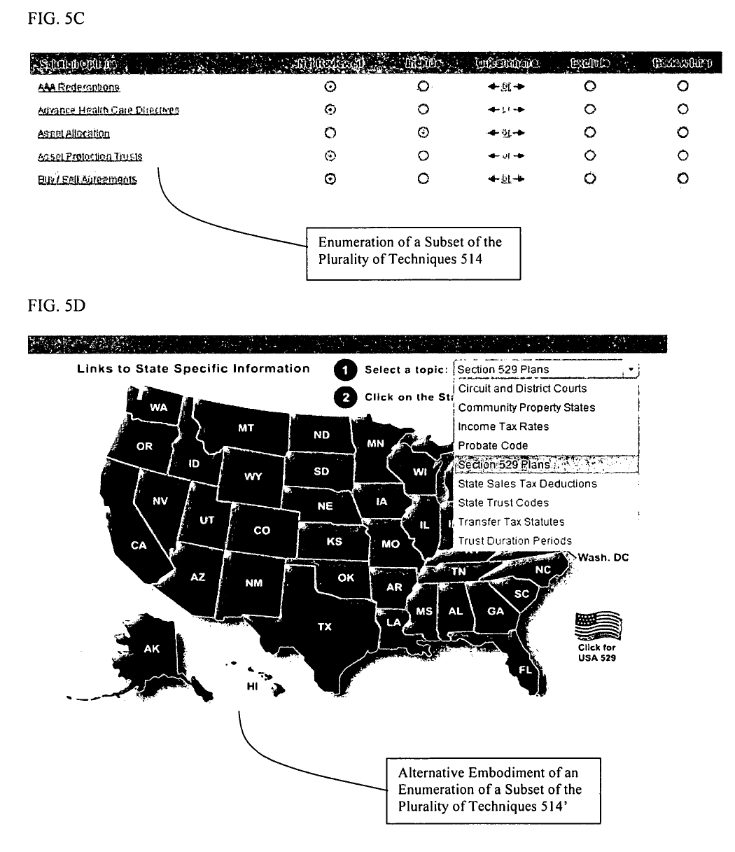

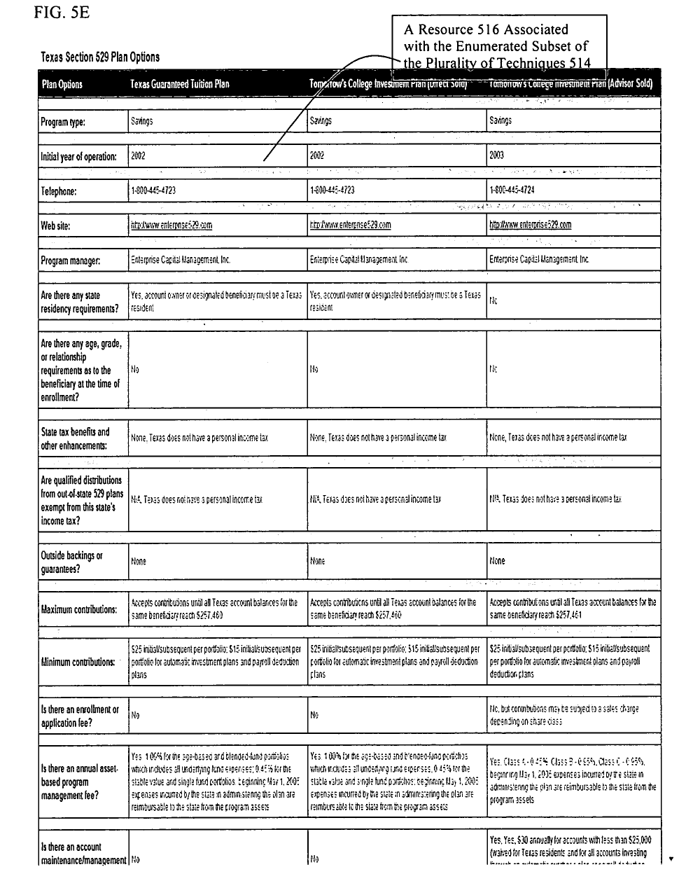

Referring now to FIG. 5A, a flow diagram depicts one embodiment of the steps taken, in an application service provider model, in a method for enumerating available resources to improve an analysis of a client and an identification of client needs by a financial services professional. In brief overview, the method includes the enumeration of a plurality of techniques (step 502). A network transmission including at least one characteristic associated with a client is received (step 504). A subset of the plurality of techniques is enumerated responsive to the received at least one characteristic (step 506). Access is provided across a network to a resource associated with the enumerated subset of techniques (step 508).

A plurality of techniques is enumerated (step 502). In one embodiment, the plurality of techniques enumerated is for use in financial planning. In another embodiment, the plurality of techniques is presented via a user interface. In still another embodiment, the plurality of techniques is accessed across a network. In some embodiments, the techniques relate to topics including, but not limited to, asset protection, asset allocation, charitable donations, diversification, education, entities, hedging risks, income taxes, investment opportunities, retirement planning, sale of assets, and wealth transfers.

A network transmission including at least one characteristic associated with a client is received (step 504). In some embodiments, the at least one characteristic identifies a financial planning of interest to the client. In other embodiments, the at least one characteristic identifies an entity having a familial relationship with the client. In still other embodiments, the at least one characteristic identifies a goal or objective of the client. In yet other embodiments, the at least one characteristic identifies a type of legal entity associated with the client.

In some embodiments, completion of a questionnaire by a client enables a financial services planner to identify the at least one characteristic associated with the client. In one embodiment, the network transmission includes at least one questionnaire comprising information provided by a client. In another embodiment, after receipt of the network transmission including the at least one characteristic, a request for completion of an additional questionnaire is transmitted to the client. In still another embodiment, after receipt of the network transmission, a request for an additional questionnaire is received from the client.

A subset of the plurality of techniques is enumerated responsive to the received at least one characteristic (step 506). In one embodiment, the enumerated subset satisfies a request for information associated with a technique in the plurality of techniques. In another embodiment, the enumerated subset addresses a need for transmission of information to a client.

In some embodiments, the subset of the plurality of techniques includes a summary of a plurality of techniques applicable to the client. In one of these embodiments, the subset of the plurality of techniques may be transmitted across a network. In another of these embodiments, the subset may be transmitted via an electronic mail message. In still another of these embodiments, a second financial services professional receives an enumeration of the subset with an identification of the client. In this embodiment, the second financial services professional may specialized in one or more of the techniques included in the subset. The second financial services professional may provide the client with additional, specialized assistance regarding one or more of the techniques in the subset.

Access is provided across a network to a resource associated with the enumerated subset of techniques (step 508). In one embodiment, access is provided across a network to a tutorial, the tutorial associated with a technique in the enumerated subset of techniques. In another embodiment, access is provided across a network to a display of a plurality of answers to frequently asked questions, the plurality of answers associated with a technique in the enumerated subset of techniques. In still another embodiment, access is provided across a network to a description of a law applicable to a technique in the enumerated subset of techniques. In yet another embodiment, access is provided across a network to a display of a sample financial planning model associated with a technique in the enumerated subset of techniques.

In some embodiments, a customized user-interface is generated responsive to the subset of techniques. In one of these embodiments, a customized user-interface is implemented to determine, responsive to an association between a first entity and financial and data, an effect on an entity in a plurality of entities related to the first entity.

Referring now to FIG. 5B, FIG. 5C, FIG. 5D, and FIG. 5E, a screen shot depicts one embodiment of a system for enumerating available resources to improve an analysis of a client and an identification of client needs by a financial services professional. In brief overview, the system includes at least one characteristic 510 and an enumeration of a plurality of techniques 512, an enumeration of a subset of the plurality of techniques 514, and a resource 516 associated with the enumerated subset of the plurality of techniques 514.

At least one characteristic 510 associated with a client is transmitted across a network. In one embodiment, a plurality of characteristics is presented to the client across a network. In another embodiment, a selection of at least one characteristic 510 is transmitted across the network, the at least one characteristic 510 associated with the client. In still another embodiment, the at least one characteristic may be an identification of a type of legal entity associated with the client. In yet another embodiment, the at least one characteristic may be a response to a questionnaire. In some embodiments, the at least one characteristic 510 may be an identification of a financial planning goal or objective of the client. In other embodiments, the at least one characteristic relates to a topic including, but not limited to, asset protection, asset allocation, charitable donations, diversification, education, entities, hedging risks, income taxes, investment opportunities, retirement planning, sale of assets, and wealth transfers.

An enumeration of a plurality of techniques 512 is presented to the client. In one embodiment, the enumeration of the plurality of techniques 512 is displayed in a user interface. In another embodiment, the enumeration of the plurality of techniques 512 is received via a transmission across a network for presentation to the client. In still another embodiment, the enumeration of the plurality of techniques 512 includes an enumeration of at least one resource associated with a technique in the plurality of techniques. In yet another embodiment, the enumeration of the plurality of techniques 512 provides access to at least one resource associated with a technique in the plurality of techniques.

In the embodiment depicted by FIG. 5B, the enumeration of the plurality of techniques 512 also provides the user with the opportunity to request additional information about a particular technique. In some embodiments, the enumeration of the plurality of techniques 512 is accompanied by access to a questionnaire that the user may complete to determine whether a technique in the plurality of techniques is applicable to a client. In one of these embodiments, depicted by FIG. 5B, the access to the questionnaire is provided by a hyperlink in the same row as the enumerated technique, under a column labeled “Questionnaire.”

In FIG. 5C, a screen shot depicts one embodiment of an enumeration of a subset of the plurality of techniques 514. In some embodiments, an enumeration of a subset of the plurality of techniques 514 is selected responsive to the at least one characteristic. In other embodiments, the subset of the plurality of techniques 514 is associated with a goal, objective, or planning technique associated with the at least one characteristic. In FIG. 5D, a screen shot depicts an alternative embodiment of an enumeration of a subset of the plurality of techniques 514. In this embodiment, rather than providing the enumeration in a list of text-based hyperlinks, a graphical user interface is provided.

In FIG. 5E, a screen shot depicts one embodiment of a resource 516 associated with the enumerated subset of techniques. In this embodiment, the resource provides a summary of educational savings plans. In some embodiments, the resource 516 provides access to additional information associated with the enumerated subset of the plurality of techniques 514. In one of these embodiments, depicted in FIG. 5E, the access is provided by including in the resource a hyperlink to the additional information. In one embodiment, the resource 516 is displayed to the client across a network. In some embodiments, the resource may be a tutorial associated with a technique in the enumerated subset of techniques. In other embodiments, the resource may be a display of a plurality of answers to frequently asked questions, the plurality of answers associated with a technique in the enumerated subset of techniques. In still other embodiments, the resource may be a display of a financial planning model associated with a technique in the enumerated subset of techniques. In yet other embodiments, the resource may provide access across a network to a law applicable to a technique in the enumerated subset of techniques.

The present invention also relates to a system and method, in an application service provider model, for assisting a financial services professional to tailor a presentation of information to a client through generation of customized reports. In some instances, multiple types of reports may be available for clients of financial services professionals. However, the number of reports available may be so numerous as to be unmanageable and have decreased utility for the client. In some embodiments of the present invention, the client is provided with an opportunity to identify the components required by the client for inclusion in a report. In one of these embodiments, the client may tailor a report to include relevant components. In another of these embodiments, a client is able to select reporting components associated with entities, transactions, or assets related to the client, as opposed to entire reports associated with the entities, transactions, or assets.

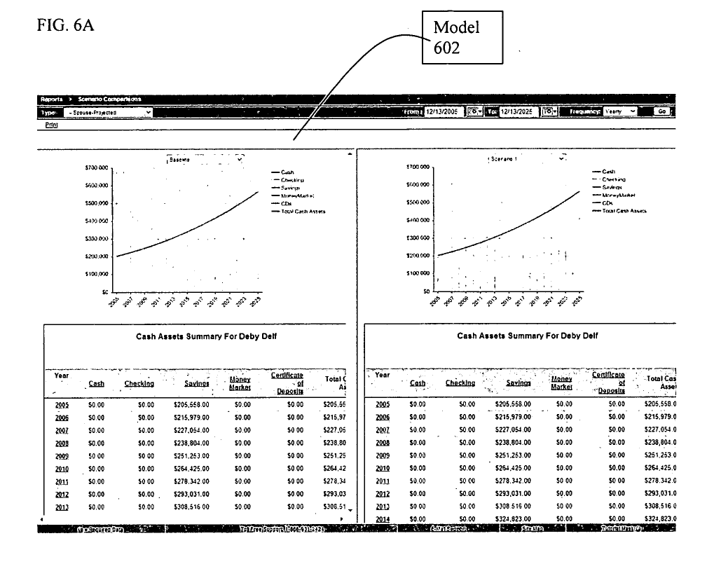

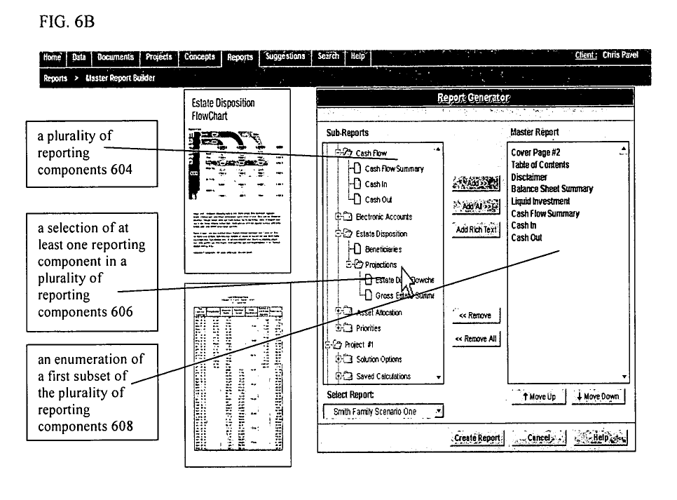

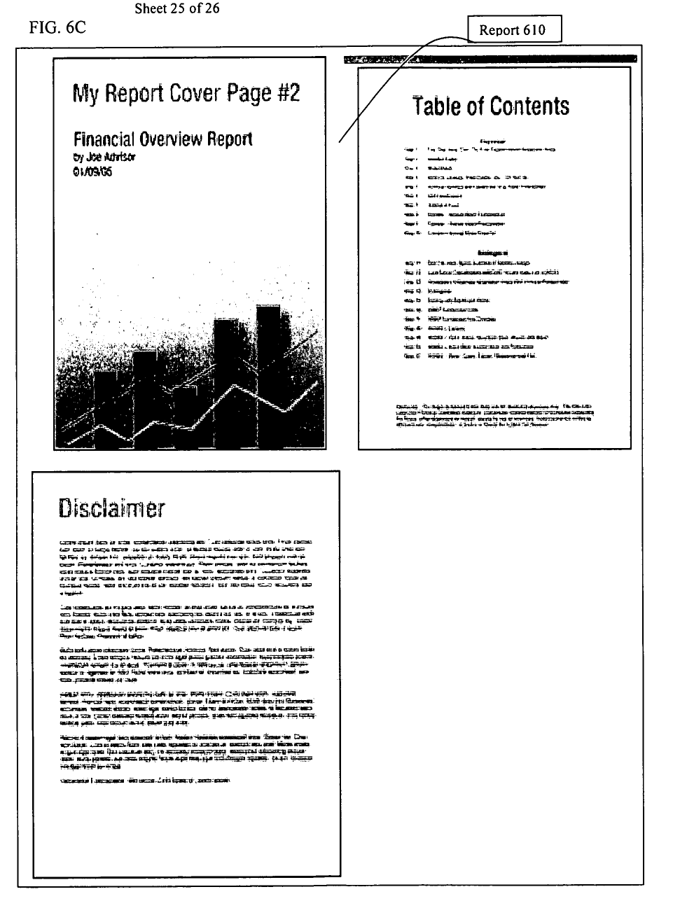

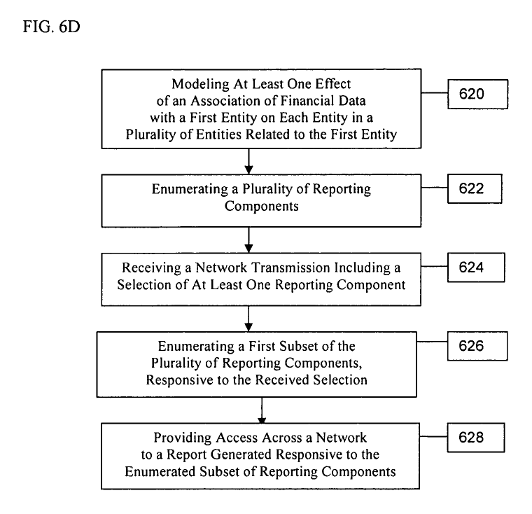

Referring now to FIG. 6A, FIG. 6B, and FIG. 6C, a system for assisting a financial services professional to tailor a presentation of information to a client through generation of customized reports includes a model, a plurality of reporting components, a selection of at least one reporting component in a plurality of reporting components, an enumeration of a first subset of the plurality of reporting components, and a report. In FIG. 6A, a screen shot depicts one embodiment of a model 602. The model 602 is of at least one effect of an association of financial data with a first entity on each entity in a plurality of entities related to the first entity. In FIG. 6B, a screen shot depicts one embodiment of a plurality of reporting components 604, a selection of at least one reporting component in a plurality of reporting components 606, and an enumeration of a first subset of the plurality of reporting components 608. In FIG. 6C, a screen shot depicts one embodiment of a report 610.

The model 602 is of at least one effect of an association of financial data with a first entity on each entity in a plurality of entities related to the first entity. In some embodiments, access to the model 602 is provided via a user interface such as a graphical representation. In other embodiments, the model 602 models an effect on the first entity of an association of financial data with the first entity. In an embodiment depicted by FIG. 6A, the model 602 depicts a projection of cash assets for an entity in the plurality of entities related to the first entity, in this case a client's spouse, both in a baseline scenario and in a modified scenario. A drop-down menu bar provided in the user interface enables a user to select a different entity in the plurality of entities or to select the first entity, in the embodiment depicted in FIG. 6A.

A plurality of reporting components 604 is presented. In one embodiment, an enumeration of the plurality of reporting components 604 is transmitted across a network. In another embodiment, a reporting component in the plurality of reporting components includes a description of an association of financial data with the first entity. In still another embodiment, a reporting component in the plurality of reporting components includes a description of at least one effect on an entity in the plurality of entities. In yet another embodiment, a reporting component in the plurality of reporting components includes a description of at least one effect on the first entity.

In some embodiments, a reporting component in the plurality of reporting components includes a link to the model 602. In other embodiments, a reporting component in the plurality of reporting components includes a link to an entity in the plurality of entities. In still other embodiments, the reporting component provides access to a graphical representation depicting the first entity and the plurality of entities related to the first entity. In one embodiment, by providing access to the plurality of entities and the graphical representation, a user may select the data for inclusion and is not limited to a set list of reporting components. In another embodiment, a user may customize a plurality of reporting components responsive to links to the plurality of entities, the graphical representation and the model 602.

In one embodiment, upon receipt of a selection of at least one reporting component, an enumeration of a second subset of the plurality of reporting components may be generated responsive to the received selection of the reporting component from the first subset. In one embodiment, depicted in FIG. 6B, the plurality of reporting components 604 may include a first subset of reporting components enumerated by category, including categories including, but not limited to, cash flow, electronic accounts, estate disposition, asset allocation, and priorities. In some embodiments, upon receiving a selection of a reporting component in the plurality of reporting components, a second subset of reporting components is enumerated. In one of these embodiments, the second subset is a subset of the first subset of reporting components. In another of these embodiments, the second subset of the first subset may include reporting components related to a category of the first subset. In the embodiment depicted in FIG. 6B, a first subset of reporting components includes a cash flow reporting component and a second subset of reporting components which is a subset of the first subset includes a cash flow summary reporting component, a cash in reporting component, and a cash out reporting component.

In some embodiments, the plurality of reporting components includes a reporting component providing a high-level summary view of at least one association of data with the first entity. In other embodiments, a reporting component in the plurality of reporting components includes a link to a reference supporting a description of an association or an effect. In one of these embodiments, the reporting component includes a link to financial data associated with the first entity. In another of these embodiments, the reporting component providing the link to the reference enables a user to “drill down” to access increasing levels of detail associated with the first entity and the plurality of entities related to the first entity. In still another of these embodiments, the reporting component providing the link to the reference provides a user with the ability to determine how a statement in a reporting component was derived from an association with the first entity or between the first entity and an entity in the plurality of entities.

The selection of at least one reporting component in a plurality of reporting components 606 is transmitted across a network. In one embodiment, a user interface receives the selection. In another embodiment, a plurality of reporting components is selected for inclusion in a report to be generated for a user.

In the enumeration of a first subset of the plurality of reporting components 608, the first subset is selected responsive to the transmitted selection. In one embodiment, the first subset 608 includes a plurality of selected reporting components. In another embodiment, the first subset 608 enumerates reporting components to be included in a report 610.

A report 610 is generated responsive to the enumerated subset of reporting components and comprises at least one reporting component in the plurality of reporting components. In one embodiment, the report 610 includes the enumerated subset of reporting components. In another embodiment, the report 610 includes a graphical depiction of a reporting component. FIG. 6C is a screen shot depicting one embodiment of the first three pages of a customized report generated for a client. In the embodiment depicted by FIG. 6C, the table of contents includes the enumeration of a first subset of the plurality of reporting components 608.

In some embodiments, the report may provide access to a resource via a hyperlink. In one of these embodiments, the report includes a link to a tutorial. In another of these embodiments, the report includes a link to an article. In still another of these embodiments, the report includes a link to a description of a reporting component in the plurality of reporting components. In yet another of these embodiments, the report includes a link between a first reporting component included in the report and a second reporting component included in the report. In some embodiments, the report includes a link to an entity in the plurality of entities. In other embodiments, the report includes a link to a characteristic associated with an entity in the plurality of entities. In still other embodiments, the report includes a link to a description of law applicable to an entity in the plurality of entities.

In one embodiment, the report includes a table of contents. In one embodiment, the report includes a description of an association between financial data and the first entity. In still another embodiment, the report includes a reporting component describing at least one effect on an entity in the plurality of entities. In yet another embodiment, the report includes a reporting component describing at least one effect on a second entity in the plurality of entities. In still another embodiment, the report includes a link between a first reporting component associated with the first entity and a second reporting component associated with an entity in the plurality of entities.

Referring now to FIG. 6D, a flow diagram depicts one embodiment of the steps taken in a method for assisting a financial services professional to tailor a presentation of information to a client through generation of customized reports. In brief overview, at least one effect of an association of financial data with a first entity on each entity in a plurality of entities related to the first entity is modeled (step 620). A plurality of reporting components is enumerated (step 622). A network transmission including a selection of at least one reporting component is received (step 624). A first subset of the plurality of reporting components is enumerated, responsive to the received selection (step 626). Access is provided across a network to a report generated responsive to the enumerated subset of reporting components (step 628).

At least one effect of an association of financial data with a first entity on each entity in a plurality of entities related to the first entity is modeled (step 620). In one embodiment, a graphical representation provides access across a network to the modeled at least one effect. In another embodiment, the effect on the first entity of the association of financial data is modeled.

A plurality of reporting components is enumerated (step 622). In one embodiment, the enumeration is transmitted across a network. In another embodiment, access to the enumeration is provided via a user interface. In still another embodiment, a reporting component in the plurality of reporting components may be selected for inclusion in a report. In yet another embodiment, a reporting component in the plurality of reporting components may be categorized according to topics described within the reporting component.

A network transmission including a selection of at least one reporting component is received (step 624). In some embodiments, the at least one reporting component is selected from the enumeration of the plurality of reporting components. In other embodiments, a selection is made of an entity in the plurality of entities or of the first entity. In one of these embodiments, an enumeration may be made of a reporting component associated with the selected entity. In another of these embodiments, reports may include generation of a balance sheet, a cash flow summary, asset allocation summaries, and estate disposition summaries. In still another of these embodiments, reports may include models or projections of effects on an entity or scenario comparisons between baseline scenarios and modified scenarios.

A first subset of the plurality of reporting components is enumerated, responsive to the received selection (step 626). In one embodiment, the first subset enumerates reporting components to be included in a report. In another embodiment, a reporting component in the first subset provides a description of at least one effect. In still another embodiment, a second subset of the plurality of reporting components is enumerated, the second subset comprising a subset of the first subset. The second subset may be generated responsive to receiving a selection of a reporting component in the first subset.

In one embodiment, a reporting component in the first subset provides a link between a reporting component in the plurality of reporting components and an entity in the plurality of entities. In another embodiment, a reporting component in the first subset provides a link to a tutorial. In still another embodiment, a reporting component in the first subset provides a link to an article. In yet another embodiment, a reporting component in the first subset provides a link to a description of a reporting component in the plurality of reporting component. In still another embodiment, a reporting component in the first subset provides a link to a reference supporting a description of the at least one effect provided by a reporting component in the plurality of reporting components. In some embodiments, providing links from a reporting component included in a report to components outside of a report, such as a modeling component or a graphical representation of the first entity or an entity related to the first entity, enables a user of the report to readily access detailed information associated with entities and assets described in a report.

Access is provided across a network to a report generated responsive to the enumerated subset of reporting components (step 628). In one of these embodiments, access is provided to a report including links between reporting components included within the report. In another of these embodiments, access is provided to a report linking a first reporting component associated with the first entity and a second reporting component associated with an entity in the plurality of entities.

The present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the invention has been shown and described with reference to specific preferred embodiments, it should be understood by those skilled in the art that various changes in form and detail may be made therein without departing from the spirit and scope of the invention as defined by the following claims.

What is claimed is:

1. In an application service provider model, a method for enumerating available resources to improve an analysis of a client and an identification of client needs by a financial services professional, the method comprising the steps of:
(a) enumerating a plurality of techniques;
(b) receiving a network transmission including at least one characteristic associated with a client;
(c) enumerating a subset of the plurality of techniques, responsive to the received at least one characteristic; and
(d) providing access across a network to a resource associated with the enumerated subset of techniques.

2. The method of claim 1, wherein step (a) further comprises enumerating a plurality of techniques for use in financial planning.

3. The method of claim 1, wherein step (b) further comprises receiving a network transmission including at least one questionnaire comprising information provided by a client.

4. The method of claim 1, wherein step (b) further comprises requesting a second characteristic from the client responsive to receiving the at least one characteristic.

5. The method of claim 1, wherein step (b) further comprises receiving a network transmission including at least one characteristic associated with a client, the at least one characteristic identifying a type of legal entity associated with the client.

6. The method of claim 1, wherein step (b) further comprises receiving a network transmission including at least one characteristic associated with a client, the at least one characteristic identifying a financial planning topic associated with the client.

7. The method of claim 1, wherein step (c) further comprises enumerating a subset of the plurality of techniques, the subset satisfying a request by the client.

8. The method of claim 1, wherein step (c) further comprises enumerating a subset of the plurality of techniques, the subset addressing a need of the client.

9. The method of claim 1, wherein step (d) further comprises providing access across a network to a tutorial, the tutorial associated with a technique in the enumerated subset of techniques.

10. The method of claim 1, wherein step (d) further comprises providing access across a network to a display of a plurality of answers to frequently asked questions, the plurality of answers associated with a technique in the enumerated subset of techniques.

11. The method of claim 1, wherein step (d) further comprises providing access across a network to a display of financial planning model associated with a technique in the enumerated subset of techniques.

12. The method of claim 1, wherein step (d) further comprises providing access across a network to a description of a law applicable to a technique in the enumerated subset of techniques.

13. The method of claim 1, further comprising the step of generating a customized user-interface responsive to the subset of techniques.

14. The method of claim 1, further comprising the step of implementing a customized user-interface to determine, responsive to an association between a first entity and financial and data, an effect on an entity in a plurality of entities related to the first entity.

15. In an application service provider model, a system for enumerating available resources to improve an analysis of a client and an identification of client needs by a financial services professional, comprising the steps of:
an enumeration of a plurality of techniques displayed in a user interface;
at least one characteristic associated with a client, the at least one characteristic transmitted across a network;
an enumeration of a subset of the plurality of techniques, the subset selected responsive to the at least one characteristic; and
a resource associated with the enumerated subset of techniques.

16. The system of claim 15, wherein the enumeration further comprises an enumeration of at least one resource associated with a technique in the plurality of techniques.

17. The system of claim 15, wherein the enumeration is received via a transmission across a network for presentation to the client.

18. The system of claim 15, wherein the at least one characteristic further comprises an identification of a type of legal entity associated with the client.

19. The system of claim 15, wherein the at least one characteristic further comprises an identification of a financial planning goal associated with the client.

20. The system of claim 15, wherein the at least one characteristic further comprises a response to a questionnaire.

21. The system of claim 15, wherein the enumeration of the subset comprises at least one technique enumerated responsive to a request for information about the at least one technique.

22. The system of claim 15, wherein the resource is displayed to the client across a network.

23. The system of claim 15, wherein the resource further comprises a tutorial associated with a technique in the enumerated subset of techniques.

24. The system of claim 15, wherein the resource further comprises a display of a plurality of answers to frequently asked questions, the plurality of answers associated with a technique in the enumerated subset of techniques.

25. The system of claim 15, wherein the resource further comprises a display of financial planning model associated with a technique in the enumerated subset of techniques.

26. The system of claim 15, wherein the resource further comprises providing access across a network to a law applicable to a technique in the enumerated subset of techniques.

27. The system of claim 15, further comprising a customized user-interface generated responsive to the subset of techniques.

28. The system of claim 15, further comprising a customized user-interface implemented to determine, responsive to an association between a first entity and financial and data, an effect on an entity in a plurality of entities related to the first entity.
